(19) United States
(12) Patent Application Publication
(10) Pub. No.: US 2007/0197737 A1
(43) Pub. Date: Aug. 23, 2007

(54) Organic light emitting device compositions, devices, and methods of making

(76) Inventors: Matthew P. Aldred, Bolton (GB); Stephen M. Kelly, Hull (GB); Mary O'Neill, Hull (GB); Panagiotis Vlachos, Athens (GR); Kai L. Woon, Pulau Ptnang (MY)

Correspondence Address: RONALD D. TRICE, 6412 BRANDON AVE., # 145, SPRINGFIELD, VA, 22150, US

(21) Appl. No.: 11/580,248

(22) Filed: Oct. 13, 2006

Related U.S. Application Data
(60) Provisional application No. 60/726,156, filed on Oct. 14, 2005.

(51) Int. Cl. C08G 69/48

(52) U.S. Cl. 525/421

(57) ABSTRACT

A charge transporting or light emitting polymer may be formed from one or more reactive mesogens where the one or more reactive mesogens have the formula:
B—S-A-S—B wherein A is a chromophore, S is a spacer, and B is an endgroup with the general formula

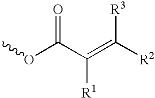

wherein R¹=an alkyl group or an aryl group, R²=an alkyl group, an aryl group, or H, and R³=an alkyl group, an aryl group, or H. The polymer may be formed by photopolymerization which occurs at fluence levels of 10 joules/cm² or less.

### RELATED APPLICATIONS

This application claims priority from, and incorporates by reference, U.S. Provisional application Ser. No. 60/726,156, filed Oct. 14, 2005.

### FIELD OF THE INVENTION

The present invention relates generally to organic light emitting device (OLED) materials, their method of manufacture and the devices made; and more particularly, to liquid crystalline emitter and charge-transport organic light emitting device (OLED) materials, their method of manufacture and the devices made.

### BACKGROUND

Organic light emitting devices (OLEDs) may be fabricated with materials that have a liquid crystalline phase and incorporate photocrosslinkable functional groups. Such materials may be crosslinked into an insoluble polymer matrix by exposure high radiation doses. Unfortunately, this results in long exposure times to suitably crosslink the materials. Accordingly, there is a strong need in the art for photocrosslinkable, liquid crystalline materials that may be crosslinked with a low dose of radiation.

### SUMMARY OF THE INVENTION

An aspect of the present invention is to provide a charge transporting or light emitting polymer including a polymer formed from at least one component having the formula: B—S-A-S—B, wherein A is a chromophore having the general formula —(Ar-Fl)ₙ-Ar—, where Ar is an aromatic diradical or a heteroaromatic diradical bonded linearly or substantially linearly to adjoining diradicals, or a single bond, Fl is a 9,9-dialkyl substituted fluorene diradical joined to adjoining diradicals at the 2 and 7 positions, the Ar and Fl diradicals are independently in each of the n subunits of the chromophore, and 2≦n≦10. The S is a spacer and B is an endgroup with the general formula 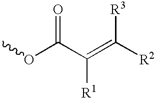
wherein R¹=an alkyl group, an aryl group or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The polymer may emit light by fluorescence or phosphorescence. The polymer may be formed by polymerization. For example, the polymerization may be photopolymerization. The polymer is formed from at least two different components. One or more of the components may be a nematic liquid crystalline material. The polymer may have a nematic structure.

Another aspect of the present invention is to provide a charge transporting or light emitting polymer including a polymer formed from at least one component having the formula: B—S-A-S—B wherein A is a chromophore having the general formula: 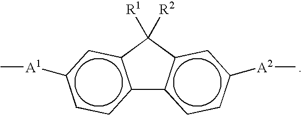
The R¹ and R² are independently selected from branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms. The A¹ and A² are independently selected from a single bond, an aryl biradical, or a series of two or more aryl biradicals concatenated together in a substantially linear chain connecting the central fluorene unit and flexible spacer units S, and at least one of A¹ and A² contain at least two heterocyclic aryl biradicals containing five or six membered aromatic rings or fused ring systems containing the heterocyclic aryl biradicals with the general formula: 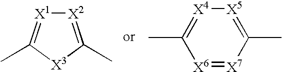
wherein one or more of X¹ and X² are independently selected from N, P, CH and As, and X³ is selected from O, NH, S, PH, Se, AsH, Te, SbH, and one or more of X⁴ to X⁷ are independently selected from N, P, CH and As, and at least one of X⁴ to X⁷ is not CH. The S is a spacer group independently selected from branched, straight chain, or cyclic alkyl groups with 3 to 18 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—,—CH═CH—, —C≡C— such that O and S atoms are not directly linked to other O or S atoms and wherein R are straight or branched chain alkyl groups, and wherein R is straight or branched chain alkyl groups. B is an endgroup with the general formula 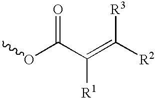
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The polymer may emit light by fluorescence or phosphorescence. The polymer may be formed by polymerization. For example, the polymerization may be photopolymerization. The polymer is formed from at least two different components. One or more of the components may be a nematic liquid crystalline material. The polymer may have a nematic structure.

Another aspect of the present invention is to provide a charge transporting or light emitting polymer including a polymer formed from at least one component having the formula: B—S-A-S—B wherein A is a chromophore having the general formula: 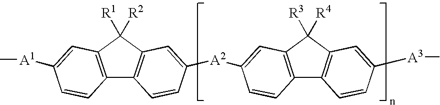
where n=1 to 6, R¹, R², R³, and R⁴ are independently selected from branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms, wherein R are straight or branched chain alkyl groups, A¹ and A³ are selected from a single bond, an aryl biradical, or a series of two or more aryl biradicals concatenated together in a substantially linear chain connecting the central fluorene units and flexible spacer units S, and each A² is independently selected from of a series of one or more aryl biradicals concatenated together in a substantially linear chain connecting adjacent fluorene units or may be of a single bond. Any one or more of A¹, A², and A³ contain at least two heterocyclic aryl biradicals containing five or six-membered aromatic rings or fused ring systems containing the heterocyclic aryl biradicals with the general formulae: 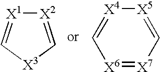
wherein one or more of X¹ and X² are independently selected from N, P, CH, and As, and X³ may be selected from O, NH, S, PH, Se, AsH, Te, SbH, and one or more of X⁴ to X⁷ are independently selected from N, P, CH, and As, and at least one of X⁴ to X⁷ is not CH. The S is a spacer group independently selected from branched, straight chain, or cyclic alkyl groups with 3 to 18 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—,—CH═CH—, —C≡C— such that O and S atoms are not directly linked to other O or S atoms and wherein R are straight or branched chain alkyl groups. The B is an endgroup with the general formula 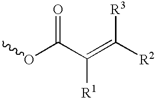
   wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The polymer may emit light by fluorescence or phosphorescence. The polymer may be formed by polymerization. For example, the polymerization may be photopolymerization. The polymer is formed from at least two different components. One or more of the components may be a nematic liquid crystalline material. The polymer may have a nematic structure.

Another aspect of the present invention is to provide a charge transporting or light emitting polymer including a polymer formed from at least one component having the formula: B—S-A-S—B where A is a chromophore having the general formula: -T₁-(F-T₂)ₚ-F-T₃- where F is a fluorene functional unit having the formula: 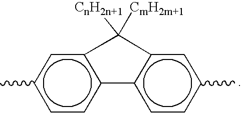
The n is from 1 to 10 and m is from 1 to 10, at least one of T₁, T₂, and T₃ have the formula: —W—X—Y— where X is selected from the group consisting of: 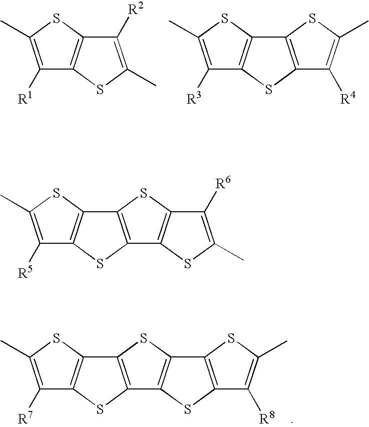
The W and Z are independently selected from the group consisting of: 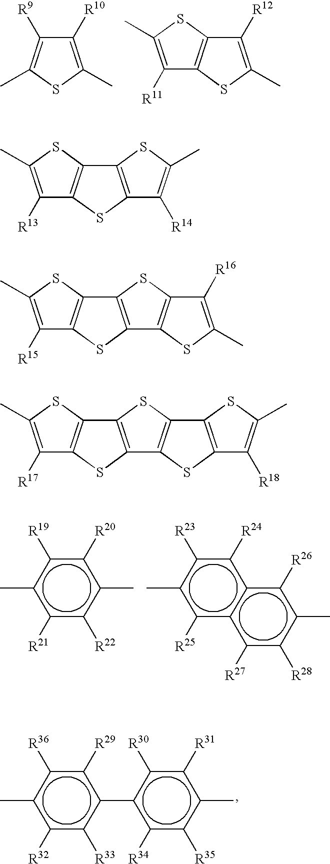
a single bond, and wherein R¹ through R³⁶ are independently selected from the group consisting of H, halogen, CN, NO₂, or branched, straight chain, or cyclic alkyl groups with 1 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—,—CO—, —COO—, —OCO—, —OCO—O—, —S—CO—, —CO—S—, —CH═CH—, —C≡C— in such a manner that O and/or S atoms are not directly linked to each other and wherein R are straight or branched chain alkyl groups. The T₁, T₂, and T₃ that do not have the general formula —W—X—Y— are independently selected from the group consisting of a single bond, 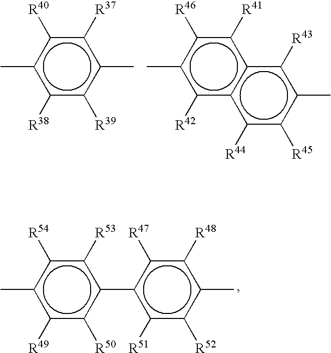
aromatic diradicals and heteroaromatic diradicals wherein R³⁷ through R⁵³ are independently selected from the group consisting of H, halogen, CN, NO₂, and branched, straight chain, or cyclic alkyl groups with 1 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms and wherein R are straight or branched chain alkyl groups. The p=0 to 6, S is a spacer, and B is an endgroup with the general formula 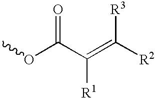
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The polymer may emit light by fluorescence or phosphorescence. The polymer may be formed by polymerization. For example, the polymerization may be photopolymerization. The polymer is formed from at least two different components. One or more of the components may be a nematic liquid crystalline material. The polymer may have a nematic structure.

Another aspect of the present invention is to provide a material for use in forming charge transporting or light emitting polymers including a reactive mesogen having the formula: B—S-A-S—B wherein A is a chromophore having the general formula: —(Ar-Fl)ₙ-Ar— wherein Ar is an aromatic diradical or a heteroaromatic diradical bonded linearly or substantially linearly to adjoining diradicals, or a single bond. The Fl is a 9,9-dialkyl substituted fluorene diradical joined to adjoining diradicals at the 2 and 7 positions. The Ar and Fl diradicals are independently in each of the n subunits of the chromophore, and 2≦n≦10, S is a spacer, and B is an endgroup with the general formula 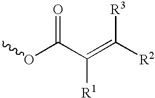
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The reactive mesogen may emit light by fluorescence or phosphorescence. The reactive mesogen may be polymerizable. For example, the reactive mesogen may be photopolymerization. The material may including another reactive mesogen having the formula: B—S-A-S—B wherein A is a chromophore, S is a spacer, and B is an endgroup with the general formula 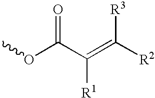
wherein R¹=an alkyl group, an aryl group, or H, R²=an alkyl group, an aryl group, or H, and R³=an alkyl group, an aryl group, or H, wherein the another reactive mesogen chemically differs from the another reactive mesogen. The reactive mesogen may be a nematic liquid crystalline material. The reactive mesogen is polymerizable into a polymer having a nematic structure.

Another aspect of the present invention is to provide a material for use in forming charge transporting or light emitting polymers including a reactive mesogen having the formula: B—S-A-S—B wherein A is a chromophore having the general formula: 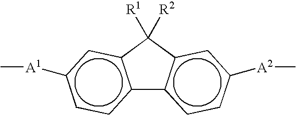
wherein R¹ and R² are independently selected from branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms, and A¹ and A² are independently selected from a single bond, an aryl biradical, or a series of two or more aryl biradicals concatenated together in a substantially linear chain connecting the central fluorene unit and flexible spacer units S, and at least one of A¹ and A² contain at least two heterocyclic aryl biradicals containing five or six membered aromatic rings or fused ring systems containing the heterocyclic aryl biradicals with the general formula: 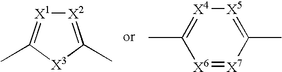
wherein one or more of X¹ and X² are independently selected from N, P, CH and As, and X³ is selected from O, NH, S, PH, Se, AsH, Te, SbH, and one or more of X⁴ to X⁷ are independently selected from N, P, CH and As, and at least one of X⁴ to X⁷ is not CH. The S is a spacer group independently selected from branched, straight chain, or cyclic alkyl groups with 3 to 18 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—,—CH═CH—, —C≡C— such that O and S atoms are not directly linked to other O or S atoms and wherein R are straight or branched chain alkyl groups, and wherein R is straight or branched chain alkyl groups. The B is an endgroup with the general formula 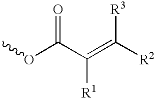
   wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The reactive mesogen may emit light by fluorescence or phosphorescence. The reactive mesogen may be polymerizable. For example, the reactive mesogen may be photopolymerization. The material may including another reactive mesogen having the formula: B—S-A-S—B wherein A is a chromophore, S is a spacer, and B is an endgroup with the general formula 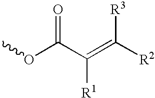
wherein R¹=an alkyl group, an aryl group, or H, R²=an alkyl group, an aryl group, or H, and R³=an alkyl group, an aryl group, or H, wherein the another reactive mesogen chemically differs from the another reactive mesogen. The reactive mesogen may be a nematic liquid crystalline material. The reactive mesogen is polymerizable into a polymer having a nematic structure.

Another aspect of the present invention is to provide a material for use in forming charge transporting or light emitting polymers including a reactive mesogen having the formula: B—S-A-S—B wherein A is a chromophore having the general formula: 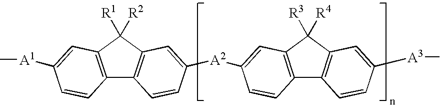
wherein n=1 to 6, R¹, R², R³, and R⁴ are independently selected from branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms, wherein R are straight or branched chain alkyl groups, A¹ and A³ are selected from a single bond, an aryl biradical, or a series of two or more aryl biradicals concatenated together in a substantially linear chain connecting the central fluorene units and flexible spacer units S, and each A² is independently selected from of a series of one or more aryl biradicals concatenated together in a substantially linear chain connecting adjacent fluorene units or may be of a single bond. Any one or more of A¹, A², and A³ contain at least two heterocyclic aryl biradicals containing five or six-membered aromatic rings or fused ring systems containing the heterocyclic aryl biradicals with the general formulae: 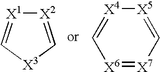
wherein one or more of X¹ and X² are independently selected from N, P, CH, and As, and X³ may be selected from O, NH, S, PH, Se, AsH, Te, SbH, and one or more of X⁴ to X⁷ are independently selected from N, P, CH, and As, and at least one of X⁴ to X⁷ is not CH. The S is a spacer group independently selected from branched, straight chain, or cyclic alkyl groups with 3 to 18 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—,—OCO—, —OCO—O—, —S—CO—, —CO—S—,—CH═CH—, —C≡C— such that O and S atoms are not directly linked to other O or S atoms and wherein R are straight or branched chain alkyl groups. The B is an endgroup with the general formula 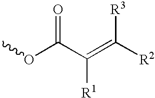
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The reactive mesogen may emit light by fluorescence or phosphorescence. The reactive mesogen may be polymerizable. For example, the reactive mesogen may be photopolymerization. The material may including another reactive mesogen having the formula: B—S-A-S—B wherein A is a chromophore, S is a spacer, and B is an endgroup with the general formula 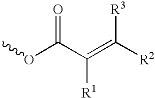
wherein R¹=an alkyl group, an aryl group, or H, R²=an alkyl group, an aryl group, or H, and R³=an alkyl group, an aryl group, or H, wherein the another reactive mesogen chemically differs from the another reactive mesogen. The reactive mesogen may be a nematic liquid crystalline material. The reactive mesogen is polymerizable into a polymer having a nematic structure.

Another aspect of the present invention is to provide a material for use in forming charge transporting or light emitting polymers including a reactive mesogen having the formula: B—S-A-S—B wherein A is a chromophore having the general formula: -T₁-(F-T₂)ₚ-F-T₃- wherein F is a fluorene functional unit having the formula: 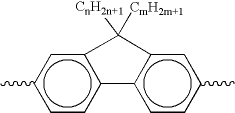
wherein n is from 1 to 10 and m is from 1 to 10. At least one of T₁, T₂, and T₃ have the formula: —W—X—Y—, wherein X is selected from the group consisting of: 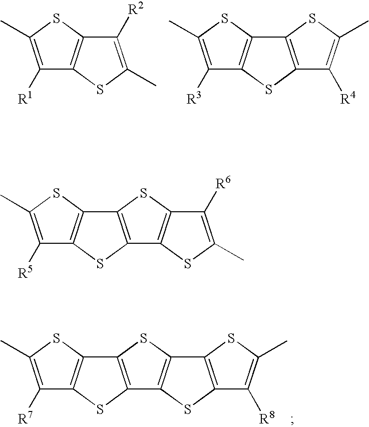
wherein W and Z are independently selected from the group consisting of: 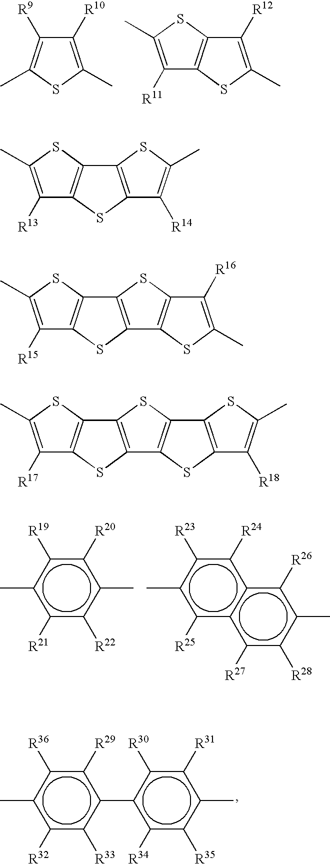
a single bond, and wherein R¹ through R³⁶ are independently selected from the group consisting of H, halogen, CN, NO₂, or branched, straight chain, or cyclic alkyl groups with 1 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— in such a manner that O and/or S atoms are not directly linked to each other and wherein R are straight or branched chain alkyl groups. The T₁, T₂, and T₃ that do not have the general formula —W—X—Y— are independently selected from the group consisting of a single bond, 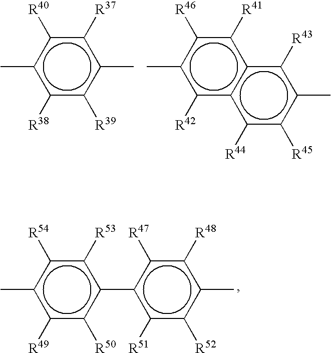
aromatic diradicals and heteroaromatic diradicals wherein R³⁷ through R⁵³ are independently selected from the group consisting of H, halogen, CN, NO₂, and branched, straight chain, or cyclic alkyl groups with 1 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms and wherein R are straight or branched chain alkyl groups. The p=0 to 6, S is a spacer, and B is an endgroup with the general formula 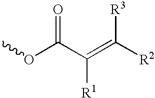
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The reactive mesogen may emit light by fluorescence or phosphorescence. The reactive mesogen may be polymerizable. For example, the reactive mesogen may be photopolymerization. The material may including another reactive mesogen having the formula: B—S-A-S—B wherein A is a chromophore, S is a spacer, and B is an endgroup with the general formula 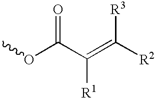
wherein R¹=an alkyl group, an aryl group, or H, R²=an alkyl group, an aryl group, or H, and R³=an alkyl group, an aryl group, or H, wherein the another reactive mesogen chemically differs from the another reactive mesogen. The reactive mesogen may be a nematic liquid crystalline material. The reactive mesogen is polymerizable into a polymer having a nematic structure.

Another aspect of the present invention is to provide a process for forming charge transporting or light emitting polymers including polymerization of a material including at least one component having the formula: B—S-A-S—B wherein A is a chromophore having the general formula: —(Ar-Fl)ₙ-Ar— wherein Ar is an aromatic diradical or a heteroaromatic diradical bonded linearly or substantially linearly to adjoining diradicals, or a single bond. The Fl is a 9,9-dialkyl substituted fluorene diradical joined to adjoining diradicals at the 2 and 7 positions, the Ar and Fl diradicals are independently in each of the n subunits of the chromophore, and 2≦n≦10. The S is a spacer, and B is an endgroup with the general formula 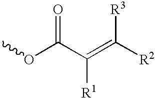
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The polymerization of the material results in a polymer that emits light by fluorescence or phosphorescence. The polymerization may be photopolymerization and may occur at fluence levels of 10 joules/cm² or less. The at least one nematic liquid crystalline component is a nematic liquid crystalline material. The polymerization of the material may form a polymer having a nematic structure and may result in a thin film layer.

Another aspect of the present invention is to provide a process for forming charge transporting or light emitting polymers including polymerization of a material including at least one component having the formula: B—S-A-S—B wherein A is a chromophore having the general formula: 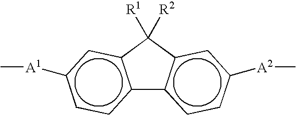
wherein R¹ and R² are independently selected from branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms, and A¹ and A² are independently selected from a single bond, an aryl biradical, or a series of two or more aryl biradicals concatenated together in a substantially linear chain connecting the central fluorene unit and flexible spacer units S, and at least one of A¹ and A² contain at least two heterocyclic aryl biradicals containing five or six membered aromatic rings or fused ring systems containing the heterocyclic aryl biradicals with the general formula: 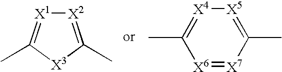
wherein one or more of X¹ and X² are independently selected from N, P, CH and As, and X³ is selected from O, NH, S, PH, Se, AsH, Te, SbH, and one or more of X⁴ to X⁷ are independently selected from N, P, CH and As, and at least one of X⁴ to X⁷ is not CH. The S is a spacer group independently selected from branched, straight chain, or cyclic alkyl groups with 3 to 18 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S —, —CH═CH—, —C≡C— such that O and S atoms are not directly linked to other O or S atoms and wherein R are straight or branched chain alkyl groups, and wherein R is straight or branched chain alkyl groups. The B is an endgroup with the general formula 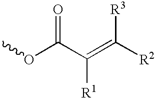
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The polymerization of the material results in a polymer that emits light by fluorescence or phosphorescence. The polymerization may be photopolymerization and may occur at fluence levels of 10 joules/cm² or less. The at least one nematic liquid crystalline component is a nematic liquid crystalline material. The polymerization of the material may form a polymer having a nematic structure and may result in a thin film layer.

Another aspect of the present invention is to provide a process for forming charge transporting or light emitting polymers including polymerization of a material including at least one component having the formula: B—S-A-S—B wherein A is a chromophore having the general formula: 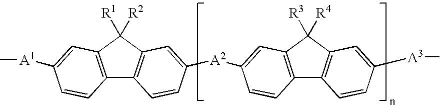
wherein n=1 to 6, R¹, R², R³, and R⁴ are independently selected from branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—,—COO—, —OCO—, —OCO—O—, —S—CO—, —CO—S—, —CH═CH—, —C≡C— such that O and S atoms are not directly linked to other O or S atoms, wherein R are straight or branched chain alkyl groups, A¹ and A³ are selected from a single bond, an aryl biradical, or a series of two or more aryl biradicals concatenated together in a substantially linear chain connecting the central fluorene units and flexible spacer units S, and each A² is independently selected from of a series of one or more aryl biradicals concatenated together in a substantially linear chain connecting adjacent fluorene units or may be of a single bond. Any one or more of A¹, A², and A³ contain at least two heterocyclic aryl biradicals containing five or six-membered aromatic rings or fused ring systems containing the heterocyclic aryl biradicals with the general formulae: 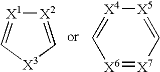
wherein one or more of X¹ and X² are independently selected from N, P, CH, and As, and X³ may be selected from O, NH, S, PH, Se, AsH, Te, SbH, and one or more of X⁴ to X⁷ are independently selected from N, P, CH, and As, and at least one of X⁴ to X⁷ is not CH. The S is a spacer group independently selected from branched, straight chain, or cyclic alkyl groups with 3 to 18 carbon atoms, which are unsubstituted, or mono- or poly-substituted by F, Cl, Br, I, or CN or wherein one or more nonadjacent CH₂ groups are replaced by , —S—, —NH—, —NR—, —SiRR—, —CO—, —COO—, —OCO—, —OCO—O—, —S—CO—, —CO—S—,—CH═CH—, —C≡C— such that O and S atoms are not directly linked to other O or S atoms and wherein R are straight or branched chain alkyl groups. The B is an endgroup with the general formula 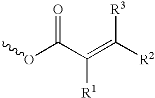
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The polymerization of the material results in a polymer that emits light by fluorescence or phosphorescence. The polymerization may be photopolymerization and may occur at fluence levels of 10 joules/cm² or less. The at least one nematic liquid crystalline component is a nematic liquid crystalline material. The polymerization of the material may form a polymer having a nematic structure and may result in a thin film layer.

Another aspect of the present invention is to provide a process for forming charge transporting or light emitting polymers including polymerization of a material including at least one component having the formula: B—S-A-S—B wherein A is a chromophore having the general formula: -T₁-(F-T₂)ₚ-F-T₃- wherein F is a fluorene functional unit having the formula: 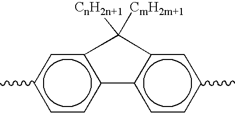
wherein n is from 1 to 10 and m is from 1 to 10, at least one of T₁, T₂, and T₃ have the formula: —W—X—Y—. The X is selected from the group consisting of: 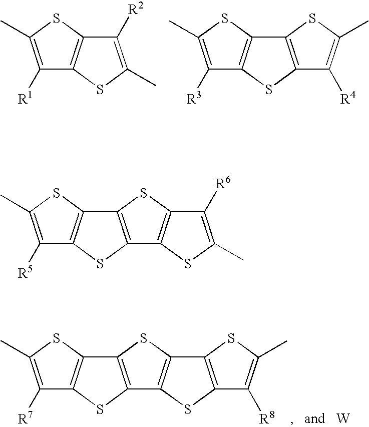
and Z are independently selected from the group consisting of: 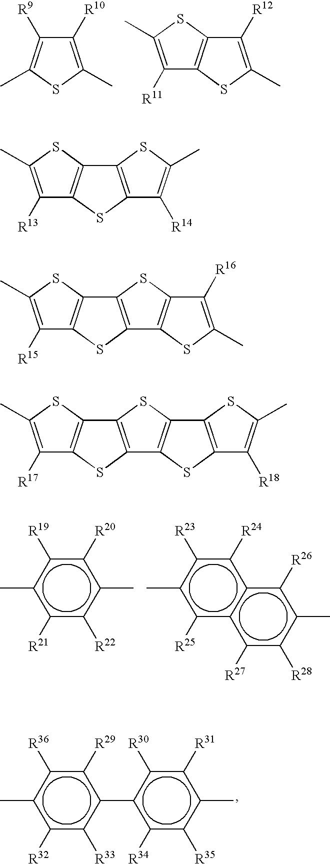
a single bond, and wherein R¹ through R³⁶ are independently selected from the group consisting of H, halogen, CN, NO₂, or branched, straight chain, or cyclic alkyl groups with 1 to 12 carbon atoms, which are unsubstituted, or mono- or poly-substituted by F, Cl, Br, I, or CN or wherein one or more nonadjacent CH2 groups are replaced by —O—, —S—, —NH—, —NR—, —SiRR—, —CO—, —OCO—O—, —OCO—, —OCO—O—, —S—CO—, —CO—S—, —CH═CH—, —C≡C— in such a manner that O and/or S atoms are not directly linked to each other and wherein R are straight or branched chain alkyl groups. The T₁, T₂, and T₃ that do not have the general formula —W—X—Y— are independently selected from the group consisting of a single bond, 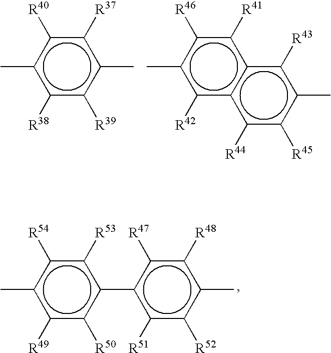
aromatic diradicals and heteroaromatic diradicals wherein R³⁷ through R⁵³ are independently selected from the group consisting of H, halogen, CN, NO₂, and branched, straight chain, or cyclic alkyl groups with 1 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms and wherein R are straight or branched chain alkyl groups. The p=0 to 6, the S is a spacer, and B is an endgroup with the general formula 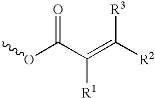
wherein R¹=an alkyl group, an aryl group, or H, R²=an alkyl group, an aryl group, or H, and R³=an alkyl group, an aryl group, or H.

One exemplary endgroup is where R¹ is a methyl group, R² is a hydrogen, and R³ is a hydrogen. Another exemplary endgroup is where R¹ is an ethyl group, R² is a hydrogen, and R³ is a hydrogen. The chromophore A may be organometallic in nature. The polymerization of the material results in a polymer that emits light by fluorescence or phosphorescence. The polymerization may be photopolymerization and may occur at fluence levels of 10 joules/cm² or less. The at least one nematic liquid crystalline component is a nematic liquid crystalline material. The polymerization of the material may form a polymer having a nematic structure and may result in a thin film layer.

Another aspect of the present invention is to provide a charge transporting or light emitting polymer including a polymer formed from at least one photopolymerable component that is photopolymerable substantially without photoinitiators and has the formula: B—S-A-S—B wherein A is a chromophore having the general formula: —(Ar-Fl)ₙ-Ar— wherein Ar is an aromatic diradical or a heteroaromatic diradical bonded linearly or substantially linearly to adjoining diradicals, or a single bond, Fl is a 9,9-dialkyl substituted fluorene diradical joined to adjoining diradicals at the 2 and 7 positions, the Ar and Fl diradicals are independently in each of the n subunits of the chromophore, and 2≦n≦10. The S is a spacer, and B is an endgroup with the general formula 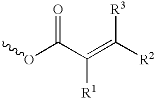
wherein R¹=an alkyl group, an aryl group, or H, R²=an alkyl group, an aryl group, or H, and R³=an alkyl group, an aryl group, or H. The polymer may be formed substantially without photoinitiators.

Another aspect of the present invention is to provide a process for forming a charge transporting or light emitting polymer including: photopolymerizing substantially without photoinitiators a material including one or more components at least one of which comprises molecules of the formula B—S-A-S—B wherein A is a chromophore having the general formula —(Ar-Fl)ₙ-Ar— wherein Ar is an aromatic diradical or a heteroaromatic diradical bonded linearly or substantially linearly to adjoining diradicals, or a single bond, Fl is a 9,9-dialkyl substituted fluorene diradical joined to adjoining diradicals at the 2 and 7 positions, the Ar and Fl diradicals are independently in each of the n subunits of the chromophore, and 2≦n≦10. The S is a spacer, and B is an endgroup with the general formula 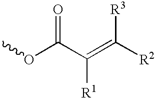
wherein R¹=an alkyl group, an aryl group, or H, R²=an alkyl group, an aryl group, or H, and R³=an alkyl group, an aryl group, or H.

Another aspect of the present invention is to provide a material for use in forming a charge transporting or light emitting polymer including a reactive mesogen that is photopolymerable substantially without photoinitiators and has the formula: B—S-A-S—B wherein A is a chromophore having the general formula: —(Ar-Fl)ₙ-Ar— wherein Ar is an aromatic diradical or a heteroaromatic diradical bonded linearly or substantially linearly to adjoining diradicals, or a single bond, Fl is a 9,9-dialkyl substituted fluorene diradical joined to adjoining diradicals at the 2 and 7 positions, the Ar and Fl diradicals are independently in each of the n subunits of the chromophore, and 2≦n≦10. The S is a spacer and B is an endgroup with the general formula 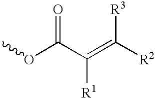
wherein R¹=an alkyl group, an aryl group, or H, R²=an alkyl group, an aryl group, or H, and R³=an alkyl group, an aryl group, or H.

Another aspect of the present invention is to provide a charge transporting or light emitting polymer including a polymer formed by polymerization of at least one component having the formula: B—S-A-S-B wherein A is a chromophore including between eight and forty aromatic or heteroaromatic rings concatenated together in a substantially linear fashion. The S is a spacer, and B is an endgroup with the general formula 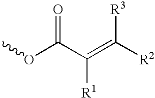
wherein R¹=an alkyl group, an aryl group or H, R²=an alkyl group, an aryl group, or H, and R³=an alkyl group, an aryl group, or H.

Another aspect of the present invention is to provide a material for use in forming charge transporting or light emitting polymers including a reactive mesogen having the formula: B—S-A-S—B wherein A is a chromophore including between eight and forty aromatic or heteroaromatic rings concatenated together in a substantially linear fashion. The S is a spacer, and B is an endgroup with the general formula 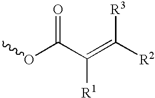
wherein R¹=an alkyl group, an aryl group or H, R²=an alkyl group, an aryl group, or H, and R³=an alkyl group, an aryl group, or H.

Another aspect of the present invention is to provide a process for forming charge transporting or light emitting polymers including polymerization of a material including at least one component having the formula B—S-A-S—B wherein A is a chromophore including between eight and forty aromatic or heteroaromatic rings concatenated together in a substantially linear fashion. The S is a spacer, and B is an endgroup with the general formula 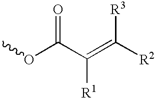
wherein R¹=an alkyl group, an aryl group or H, R²=an alkyl group, an aryl group, or H, and R³=an alkyl group, an aryl group, or H.

Another aspect of the present invention is to provide a charge transporting or light emitting polymer including a polymer formed from at least one component having the formula: B—S-A-S—B wherein A is a chromophore, S is a spacer, and B is an endgroup with the general formula 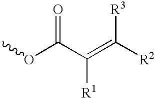
wherein R¹=an alkyl group, an aryl group or H, R²=an alkyl group, an aryl group, or H, and R³=an alkyl group, an aryl group, or H. The polymer has an electroluminescent radiance of at least 95 percent of electroluminescent radiance of the at least one component.

Another aspect of the present invention is to provide a process for forming charge transporting or light emitting polymers including polymerization of a material including at least one component having the formula: B—S-A-S—B wherein A is a chromophore, S is a spacer, and B is an endgroup with the general formula 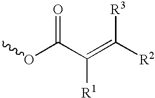
wherein R¹=an alkyl group, an aryl group or H, R²=an alkyl group, an aryl group, or H, and R³=an alkyl group, an aryl group, or H. The material after polymerization has an electroluminescent radiance of at least 95 percent of electroluminescent radiance of the material before polymerization. The polymerization of the material may occur in a substantially oxygen free environment. The substantially oxygen free environment may have less than 8 parts per million of oxygen, or more advantageously, the substantially oxygen free environment may have less than 5 parts per million of oxygen. The polymerization of the material may occur in a substantially water free environment. The substantially water free environment has less than 50 parts per million of water, or more advantageously, the substantially water free environment has less than 5 parts per million of water. The polymerization of the material may occur in a substantially water free and oxygen environment.

### BRIEF DESCRIPTION OF THE DRAWINGS

FIG. 1, FIG. 2 and FIG. 3 are an exemplary synthesis for:

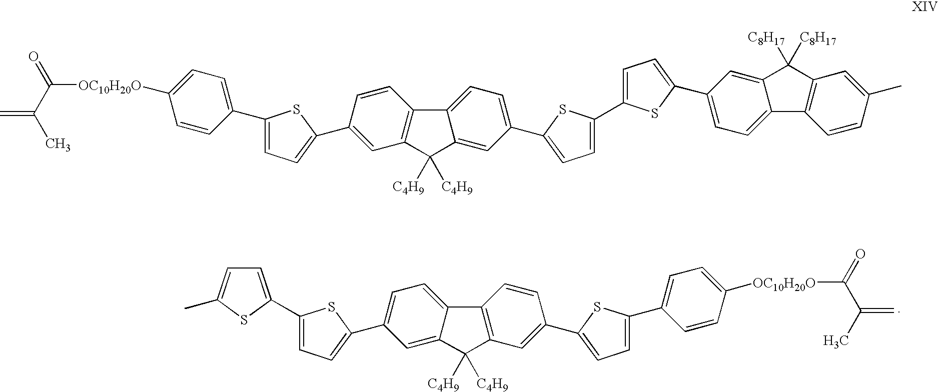

FIG. 4 and FIG. 5 are an exemplary synthesis for:

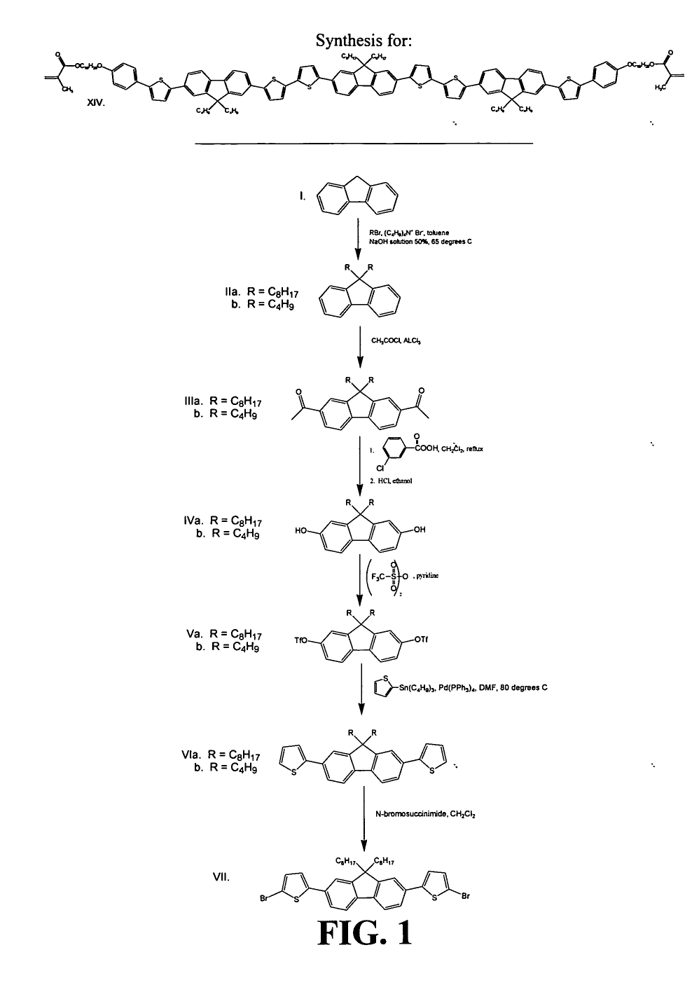

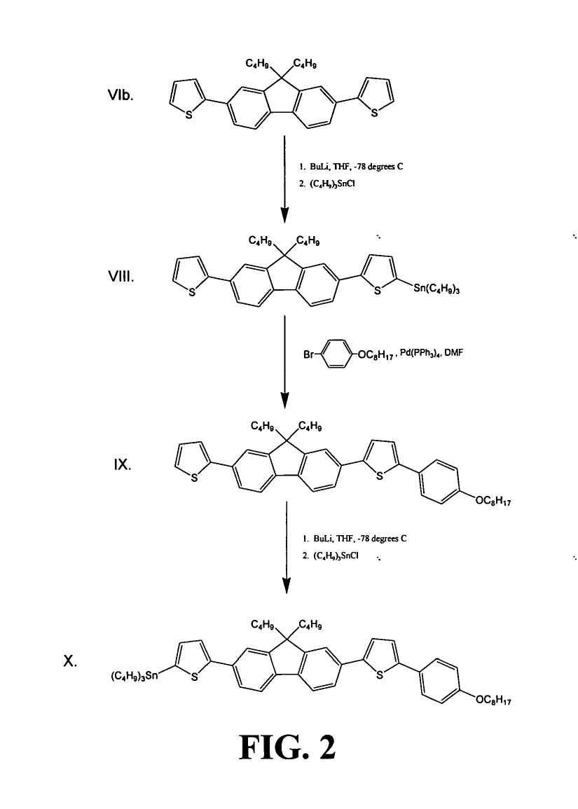

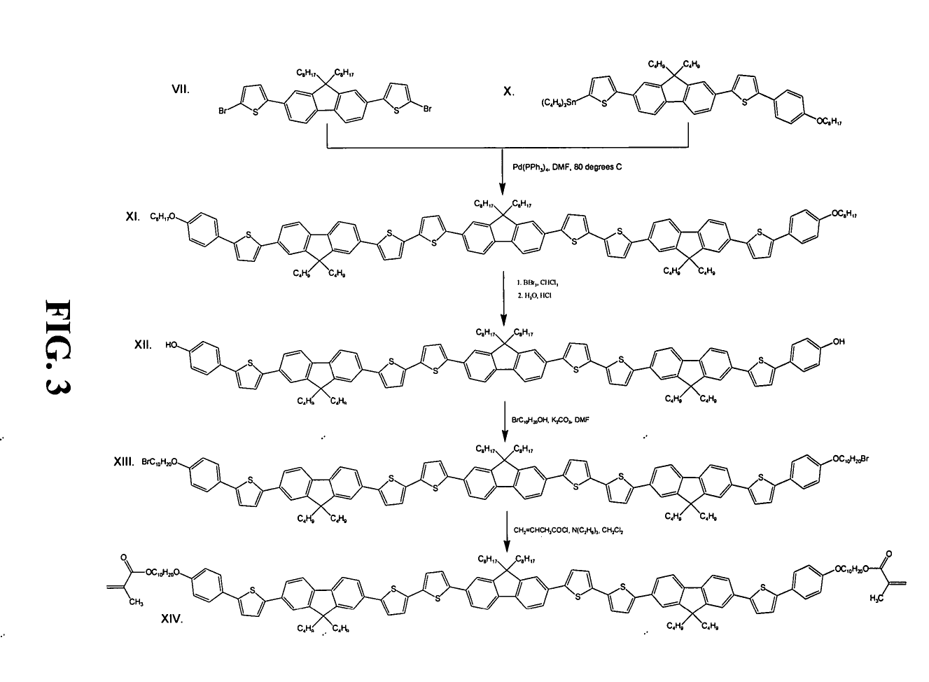

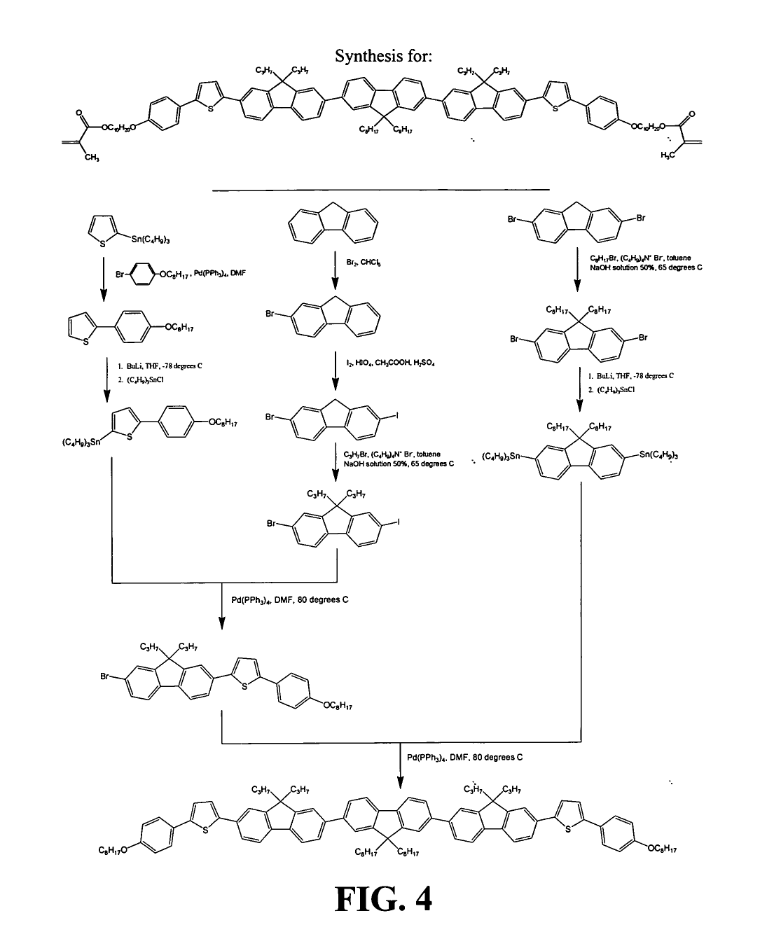

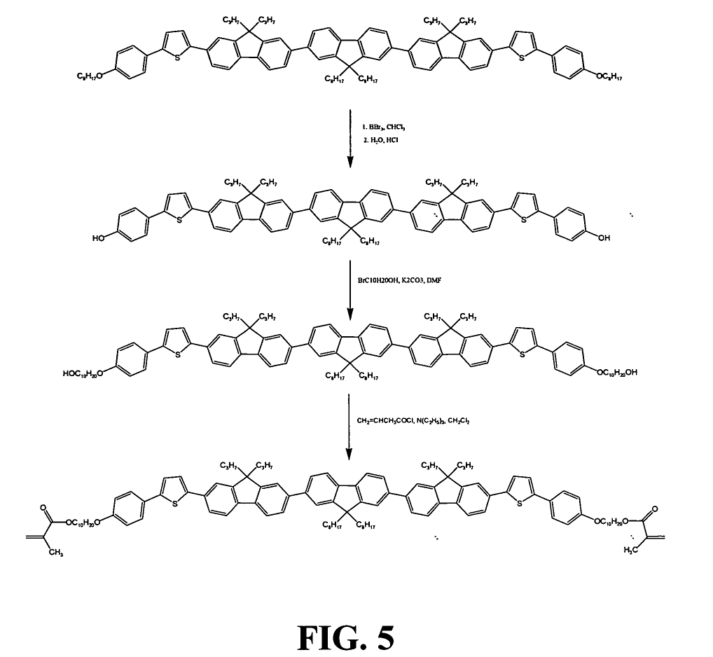

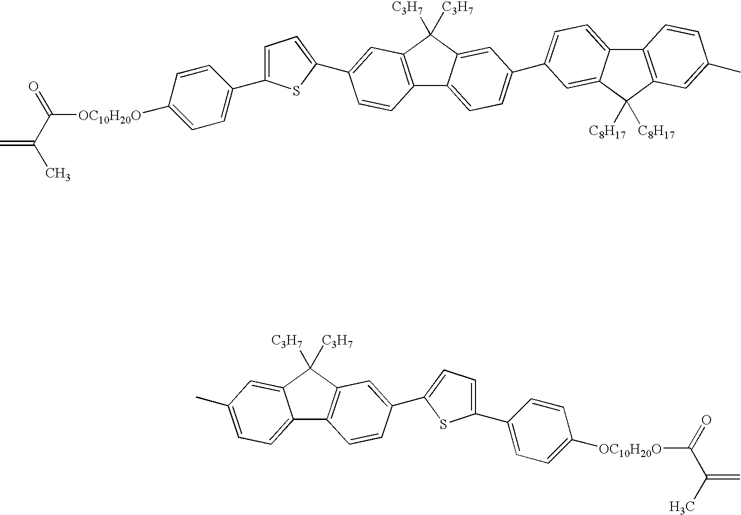

### DETAILED DESCRIPTION

Many materials having photocrosslinkable functional groups require ultraviolet fluences greater than 100 joules/cm². in order to crosslink those materials. Unfortunately, such irradiation levels may make practical manufacturing of organic light emitting diodes difficult. For example, crosslinking of an approximately 2×2 cm coupon of an approximately 50 μm thick film of the compound 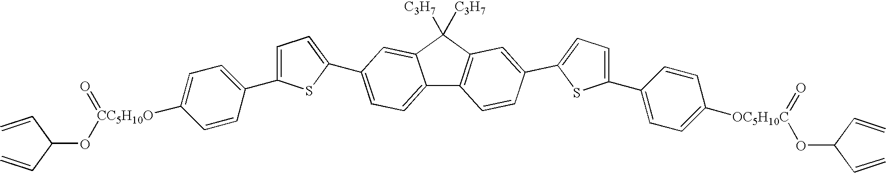
may be completely crosslinked in approximately 2 hours of exposure time with a 40 milliwatt HeCd laser. This length of exposure time is impractical for volume manufacturing of devices.

Acrylic crosslinking groups are more reactive to UV radiation than the pentadiene groups utilized in the compound above. Although materials containing these groups might be expected to crosslink more rapidly, previous attempts at using methacrylate and acrylate crosslinking groups in these applications have failed. For example, see Contoret et al., The Photopolymerization and Cross-Linking of Electroluminescent Liquid Crystal Containing Methacrylate and Diene Photopolymerizable End Groups for Multilayer Organic Liquid Emitting Diodes, Chem. Mater., Vol. 14, No. 4, 2002 1477-1487, which is incorporated herein in its entirety by this reference. One of the reasons these attempts have failed is because the luminous efficiency of the photocrosslinked materials was degraded substantially after exposure to UV radiation (e.g., in some cases the photocrosslinked materials after polymerization had an electroluminescent radiance of less than 60 percent of electroluminescent radiance of the photocrosslinked materials before polymerization). However, crosslinking groups (e.g., methacrylate and other acrylics) may be successfully utilized to provide photocrosslinking in organic compounds in applications such as OLED materials and charge transporting materials without the foregoing problems. Exemplary conditions for rapid UV induced photocrosslinking to high efficiency emissive materials include one or more of:

rigorous exclusion of oxygen and/or water from the photoreactive material during crosslinking

the use of longer aromatic molecular cores in the crosslinkable molecules (e.g., between eight and forty aromatic or heteroaromatic rings concatenated together in a substantially linear fashion). One example is a molecule whose aromatic cores contain multiple fluorene units, such as the following:

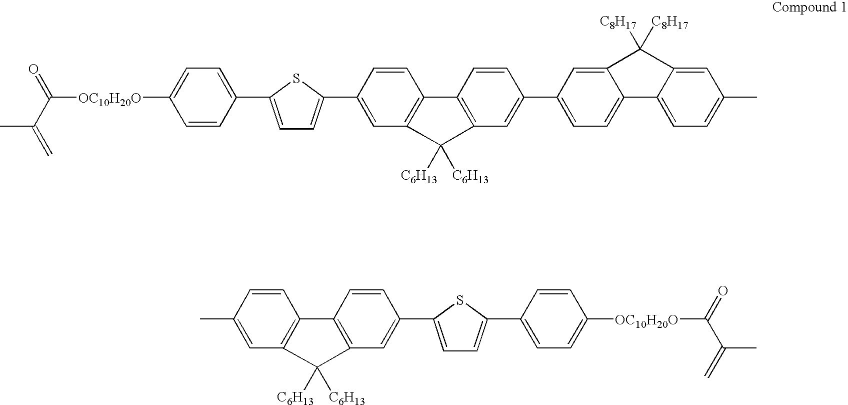

By following the above conditionals, materials after polymerization have an electroluminescent radiance of at least 95 percent of electroluminescent radiance of the material before polymerization.

The rigorous exclusion of oxygen results in a substantially oxygen free environment. For example, a substantially oxygen free environment may less than 8 parts per million of oxygen, or more advantageously, the substantially oxygen free environment may have less than 5 parts per million of oxygen.

The rigorous exclusion of water results in a substantially water free environment. For example, a substantially water free environment may less than 50 parts per million of water, or more advantageously, the substantially water free environment may have less than 5 parts per million of water.

Nematic materials are the advantageous precursors for producing polymer matrix layers for use in OLEDs because of their lower viscosities and resulting more facile crosslinking under irradiation. The presence of fluorene units in the molecular cores provides a further advantage in that it stabilizes the nematic phase versus smectic phases and lowers the melting point of the material. The very long molecular cores lead to higher melting materials that are otherwise unusable without this melting point lowering.

Alternatively, other acrylic crosslinking substituents may be use in place of methacrylate substituents. For example, ethacrylates of the general formula: B—S-A-S—B where A is a chromophore, S is a spacer, and B is an endgroup with the general formula 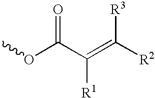
wherein R¹=an ethyl group, R²=H, and R³=H.

Another example is tiglates of the general formula: B—S-A-S—B where A is a chromophore, S is a spacer, and B is an endgroup with the general formula 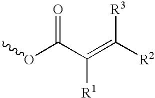
wherein R¹=a methyl group, R²=H, and R³=a methyl group.
   However, acrylate-substituted reactive mesogens (R1=R2=R3=H) have been shown not to work as precursors for polymer matrix emissive layers. The photocrosslinking process does degrade the luminescent properties of these materials.

In general acrylic materials of the general formula: B—S-A-S—B where A is a chromophore, S is a spacer, and B is an endgroup with the general formula 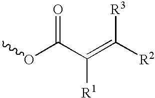
wherein R¹=an alkyl group or an aryl group, R²=an alkyl group, an aryl group, or H, and R³=an alkyl group, an aryl group, or H may be used as emitter or charge transporting materials.

Materials may have identical end groups or may have different end groups on individual molecules. For example, materials may be used in which acrylic end groups of the above types are mixed such as in the following material: 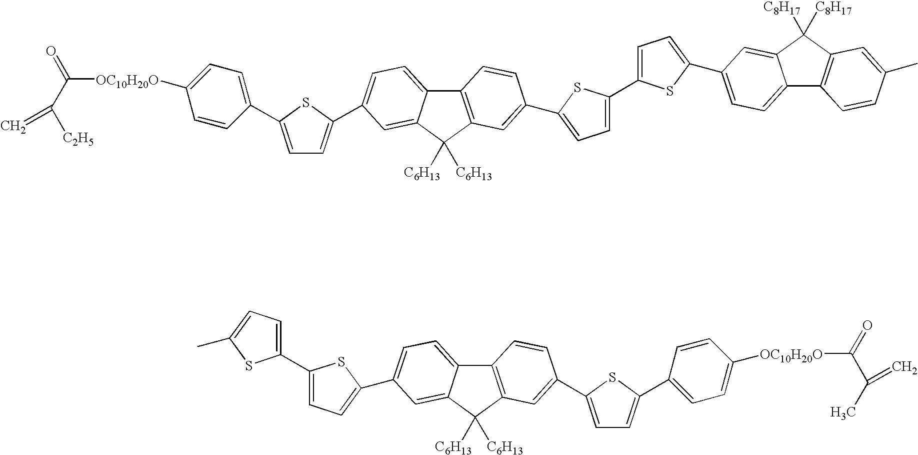
These materials may be used as precursors to produce polymer matrix emissive films upon crosslinking.

Alternatively, acrylic crosslinking groups of the above described types may be used as one of the “B” crosslinking groups in the above formulations while the second crosslinking group has some other chemistry. For example, the following material:

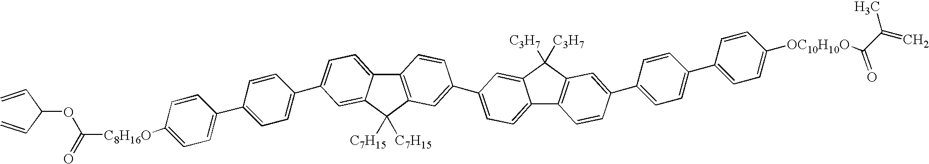

Mixtures of the methacrylate and other acrylic-substituted reactive mesogens described above with other reactive mesogens of the same types or with reactive mesogens of different types also may be advantageously used to prepare luminescent or charge transporting polymer matrix films. As an example, a mixture of four parts of the material: 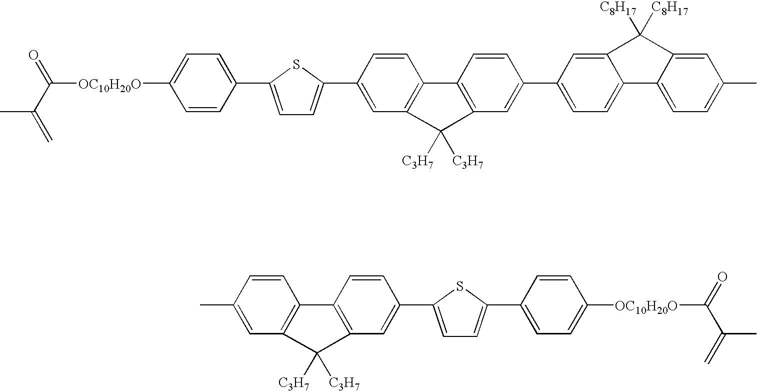
and one part of the material: 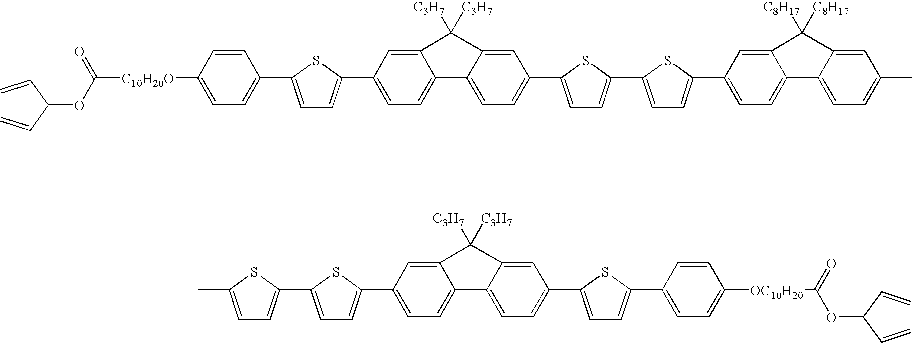
may be used advantageously to produce a green light emitting polymer matrix layer.

Other advantageous materials useful in producing light emitting layers are fluorene containing materials with longer molecular lengths having the general formula: B—S-A-S—B where S is a spacer and A is a chromophore of general formula —(Ar-Fl)ₙ-Ar—. The Ar is an aromatic diradical or a heteroaromatic diradical bonded linearly or substantially linearly to adjoining diradicals, or a single bond; the Fl is a 9,9-dialkyl substituted fluorene diradical joined to adjoining diradicals at the 2 and 7 positions. The value of n is between 2 and 10 (2≦n≦10). The Ar and Fl diradicals may be chosen independently in each of the n subunits of the chromophore. B is an endgroup with the general formula 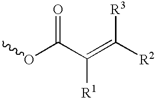
wherein R¹=an alkyl group or an aryl group, R²=an alkyl group, an aryl group, or H, and R³=an alkyl group, an aryl group, or H. An example of this type of material is:

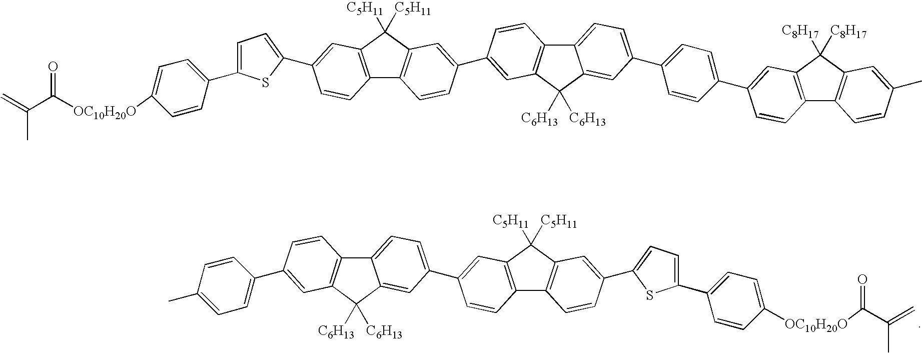

Polymers produced from reactive mesogen materials containing multiple adjacent heterocyclic rings can support higher currents in electronic devices than equivalent materials with no or isolated heterocyclic rings. Therefore, these materials can be highly useful for fabricating carrier transport as well as emitter layers. Materials of this type have the general formula: 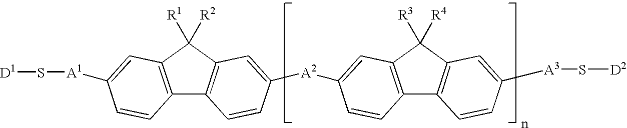
wherein A¹ and A³ are selected from a single bond, an aryl biradical, or a series of two or more aryl biradicals concatenated together in a substantially linear chain connecting the central fluorene units and flexible spacer units S. Each of n A² may independently be formed of a series of one or more aryl biradicals concatenated together in a substantially linear chain connecting adjacent fluorene units or may be a single bond. Alternatively, (Gene, is this correct) any one, some, or all of A¹, A², and A³ may contain at least two heterocyclic aryl biradicals containing five or six-membered aromatic rings with the general formulae: 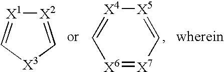
one or more of X¹ and X² are independently selected from, but not limited to, N, P, CH, and As,
X³ may be selected from O, NH, S, PH, Se, AsH, Te, SbH, and
one or more of X⁴ to X⁷ are independently selected from N, P, CH, and As, wherein at least one of X⁴ to X⁷ is not CH. The heterocyclic biradicals may be formed of the individual rings pictured above or fused ring systems containing those heterocyclic rings. The S are spacer groups independently comprising branched, straight chain, or cyclic alkyl groups with 3 to 18 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—,—CH═CH—, —C≡C— such that O and S atoms are not directly linked to other O or S atoms and wherein R are straight or branched chain alkyl groups. The D¹ and D² groups are independently selected from groups having the general formula 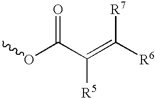
wherein R⁵=an alkyl group or an aryl group, R⁶=an alkyl group, an aryl group, or H, and R⁷=an alkyl group, an aryl group, or H. An example of a material of this type is the compound: 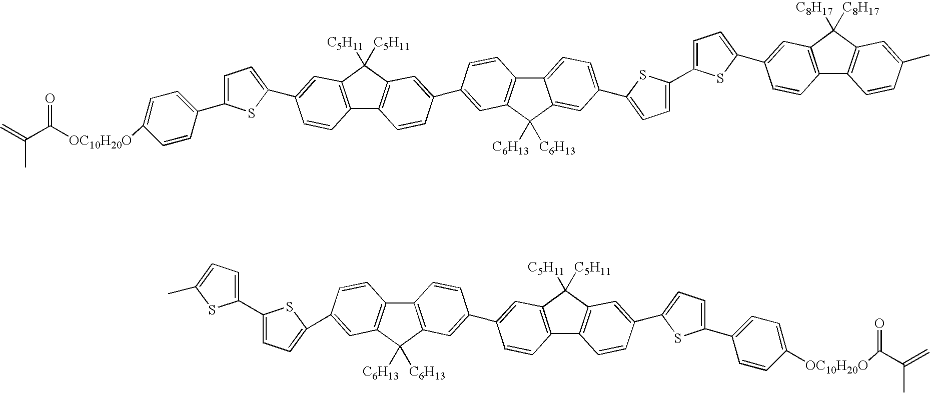
   Other examples of materials of this type are: 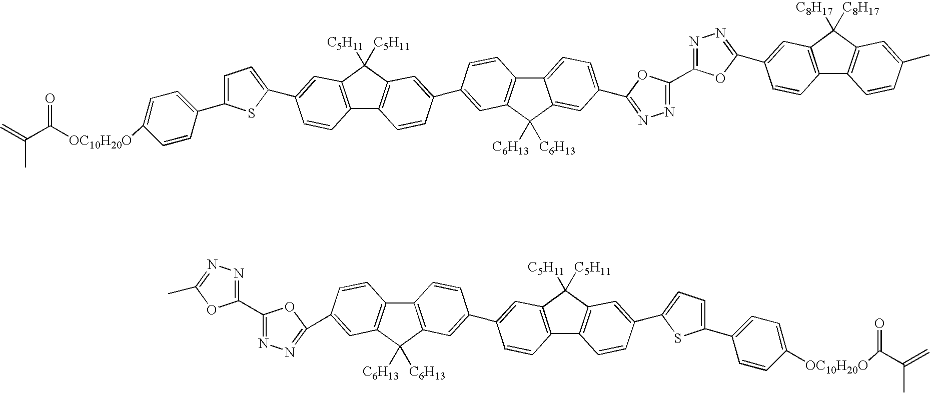
   and

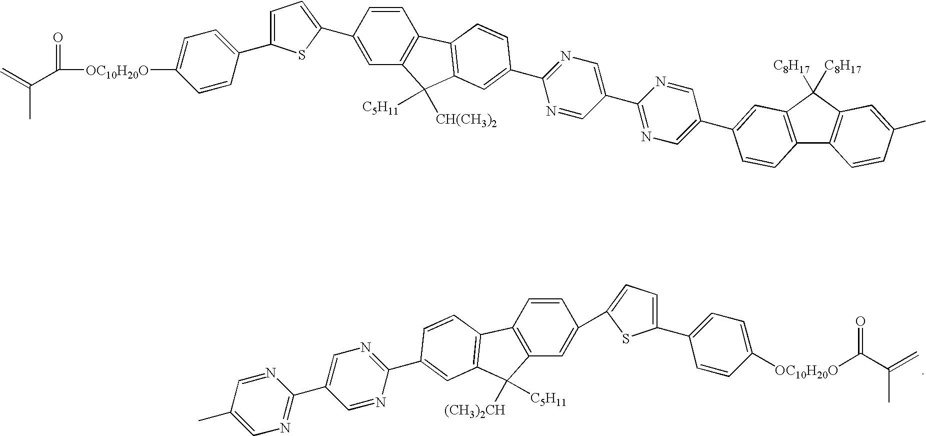

The substitution of fused ring heterocycles for single heterocyclic rings tends to increase the efficiency of the polymers produced from reactive mesogens because rotations about single bonds tend to reduce the quantum efficiency of luminescent molecules. Exemplary fused ring systems are the thienothiophenes. Thienothiophene reactive mesogen molecules tend to form relatively immobile smectic phases. However, the inclusion of fluorene diradicals in the molecular backbone leads to nematic materials. Molecules of this type have the general formula: B₁—S₁-T₁-(F-T₂)ₚ-F-T₃-S₂—B₂
wherein B₁ and B₂ are independently selected from groups having the general formula 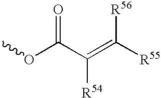
wherein R⁵⁴=an alkyl group or an aryl group, R⁵⁵=an alkyl group, an aryl group, or H, R⁵⁶=an alkyl group, an aryl group, or H. The F group is a fluorene functional unit having the formula: 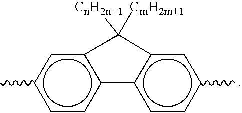
wherein n is from 1 to 10 and m is from 1 to 10; S₁ and S₂ are spacer units; at least one of T₁, T₂, and T₃ have the formula: —W—X—Y—;
where X is selected from the group consisting of: 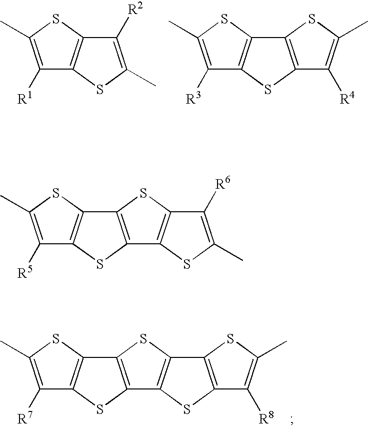
wherein W and Z are independently selected from the group consisting of: 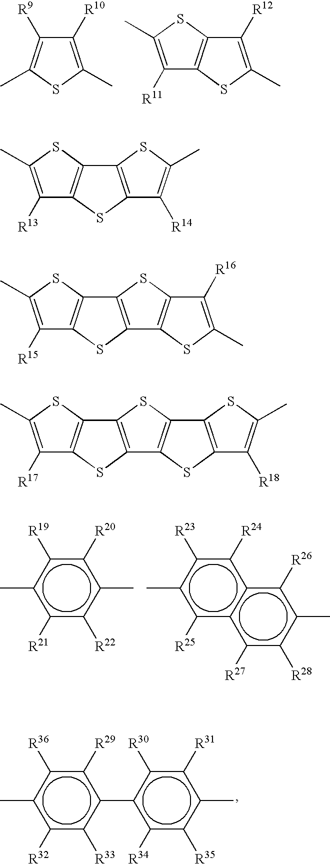
   a single bond, and wherein R¹ through R³⁶ are independently selected from the group consisting of H, halogen, CN, NO₂, or branched, straight chain, or cyclic alkyl groups with 1 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— in such a manner that O and/or S atoms are not directly linked to each other and wherein R are straight or branched chain alkyl groups;

wherein the T₁, T₂, and T₃ that do not have the general formula —W—X—Y— are independently selected from the group consisting of a single bond, 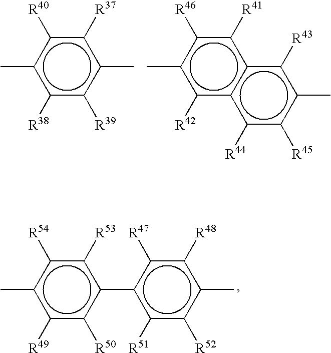
aromatic diradicals and heteroaromatic diradicals wherein R³⁷ through R⁵³ are independently selected from the group consisting of H, halogen, CN, NO₂, and branched, straight chain, or cyclic alkyl groups with 1 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms and wherein R are straight or branched chain alkyl groups; and

wherein p =0 to 6.

Examples of this type of material are:

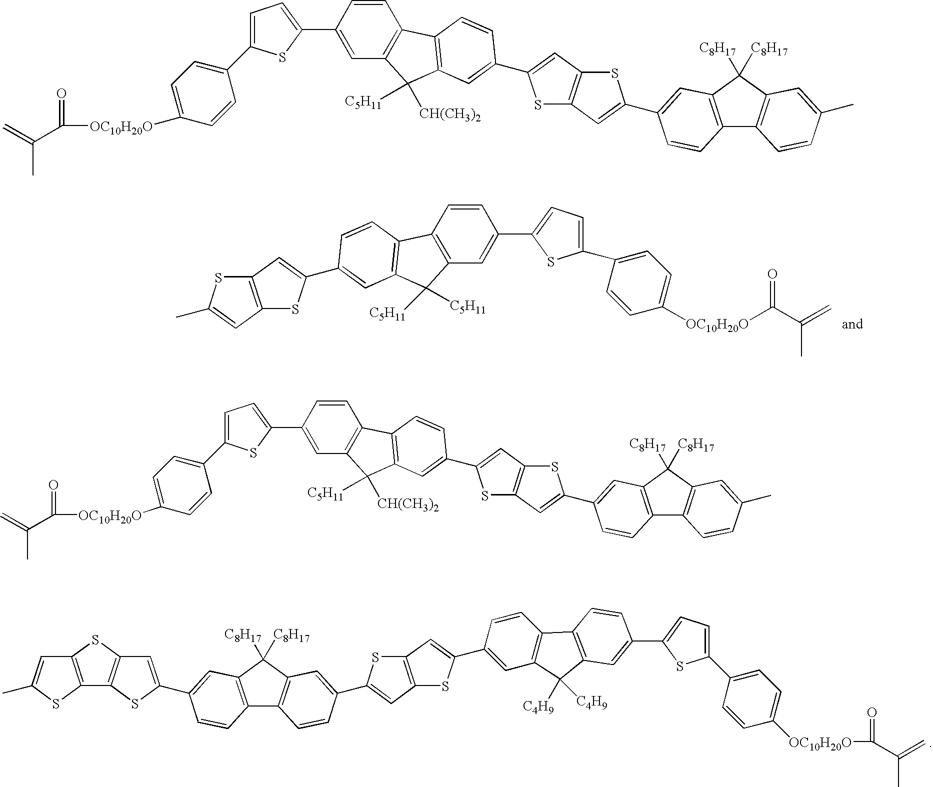

Exemplary fabrication of a device from Compound 1 and the resultant device: OLEDs were fabricated on a glass substrate (25 mm×45 mm×1 mm) covered with an IndiumTinOxide (ITO) transparent anode and a polystyrene sulphonate/polyethylene dioxythiophene (PSS/PEDOT) (Baytron P VP CH 8000, Bayer) EL grade layer (thickness 45 nm) deposited by spin-coating. The PSS/PEDOT layer was baked at 165° C. for 5 minutes in order to cure the layer and remove volatile components. Thin films of the light-emitting material Compound 1 was prepared by spin coating from a 1.0% by weight solution in toluene followed by baking at 60° C. The films were crosslinked by UV irradiation at room temperature using a HeCd laser at 325 nm. A fluence of 10 J cm⁻² was used. A hole-blocking layer (6 nm) of commercially available (H. W. Sands) 3-(4-biphenylyl)-4-phenyl-5-tert-butylphenyl-1,2,4-triazole (TAZ) was deposited on top of the crosslinked emission layer by vapor deposition using a vacuum better than 10⁻⁶ mbar. Layers of lithium fluoride (7 Å) and aluminum (1100 Å) were sequentially deposited in the same chamber as a combined cathode.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. A charge transporting or light emitting polymer comprising:
a polymer formed from at least one component having the formula: B—S-A-S—B
wherein
A is a chromophore having the general formula:
—(Ar-Fl)ₙ-Ar—
wherein
Ar is an aromatic diradical or a heteroaromatic diradical bonded linearly or substantially linearly to adjoining diradicals, or a single bond;
Fl is a 9,9-dialkyl substituted fluorene diradical joined to adjoining diradicals at the 2 and 7 positions;
the Ar and Fl diradicals are independently in each of the n subunits of the chromophore; and
2≦n≦10;
S is a spacer; and
B is an endgroup with the general formula 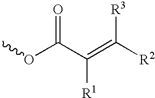
wherein
R¹=an alkyl group, an aryl group or H,
R²=an alkyl group, an aryl group, or H, and
R³=an alkyl group, an aryl group, or H.

2. The polymer of claim 1, wherein
R¹ is a methyl group,
R² is a hydrogen, and
R³ is a hydrogen.

3. The polymer of claim 1, wherein
R¹ is an ethyl group,
R² is a hydrogen, and
R³ is a hydrogen.

4. The polymer of claim 1, wherein the chromophore A is organometallic in nature.

5. The polymer of claim 1, wherein the polymer emits light by fluorescence or phosphorescence.

6. The polymer of claim 1, wherein the polymer is formed by polymerization.

7. The polymer of claim 6, wherein the polymerization is photopolymerization.

8. The polymer of claim 1, wherein the polymer is formed from at least two different components.

9. The polymer of claim 8, wherein the at least one component is a nematic liquid crystalline material.

10. The polymer of claim 1, wherein the polymer has a nematic structure.

11. A charge transporting or light emitting polymer comprising:
a polymer formed from at least one component having the formula: B—S-A-S—B
wherein
A is a chromophore having the general formula: 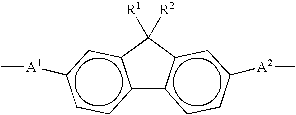
wherein
R¹ and R² are independently selected from branched, straight chain, or cyclic alkyl groups with 3 to 12 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, —COO—, —OCO—, —OCO—O—, —S—CO—, —CO—S—, —CH═CH—, —C≡C— such that O and S atoms are not directly linked to other O or S atoms, and
A¹ and A² are independently selected from a single bond, an aryl biradical, or a series of two or more aryl biradicals concatenated together in a substantially linear chain connecting the central fluorene unit and flexible spacer units S, and at least one of A¹ and A² contain at least two heterocyclic aryl biradicals containing five or six membered aromatic rings or fused ring systems containing the heterocyclic aryl biradicals with the general formula: 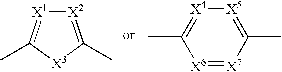
wherein
one or more of X¹ and X² are independently selected from N, P, CH and As, and
X³ is selected from O, NH, S, PH, Se, AsH, Te, SbH, and
one or more of X⁴ to X⁷ are independently selected from N, P, CH and As,
at least one of X⁴ to X⁷ is not CH, and
S is a spacer group independently selected from branched, straight chain, or cyclic alkyl groups with 3 to 18 carbon atoms, which are unsubstituted, or mono- or poly-substituted by F, Cl, Br, I, or CN or wherein one or more nonadjacent CH₂ groups are replaced by —O—, —S—, —NH—, —NR—, —SiRR—, —CO—, COO-, —OCO—, —OCO—O—, —S—CO—, —CO—S—,—CH═CH—, —C≡C— such that O and S atoms are not directly linked to other O or S atoms and wherein R are straight or branched chain alkyl groups, and wherein R is straight or branched chain alkyl groups; and
B is an endgroup with the general formula 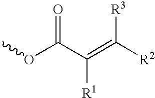
wherein
R¹=an alkyl group, an aryl group, or H,
R²=an alkyl group, an aryl group, or H, and
R³=an alkyl group, an aryl group, or H.

12. The polymer of claim 11, wherein
R¹ is a methyl group,
R² is a hydrogen, and
R³ is a hydrogen.

13. The polymer of claim 11, wherein
R¹ is an ethyl group,
R² is a hydrogen, and
R³ is a hydrogen.

14. The polymer of claim 11, wherein the chromophore A is organometallic in nature.

15. The polymer of claim 11, wherein the polymer emits light by fluorescence or phosphorescence.

16. The polymer of claim 11, wherein the polymer is formed by polymerization.

17. The polymer of claim 16, wherein the polymerization is photopolymerization.

18. The polymer of claim 11, wherein the polymer is formed from at least two different components.

19. The polymer of claim 11, wherein the at least one component is a nematic liquid crystalline material.

20. The polymer of claim 11, wherein the polymer has a nematic structure.

21-132. (canceled)
